(19) United States
(12) Patent Application Publication
(10) Pub. No.: US 2010/0143003 A1
(43) Pub. Date: Jun. 10, 2010

(54) IMAGE FORMING APPARATUS AND DEVELOPING DEVICE FOR USE WITH THE IMAGE FORMING APPARATUS

(75) Inventor: Kazuhiro SAITO, Toyokawa-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/634,724

(22) Filed: Dec. 10, 2009

(30) Foreign Application Priority Data
Dec. 10, 2008 (JP) 2008-314073

(51) Int. Cl. G03G 15/08

(52) U.S. Cl. 399/281

(57) ABSTRACT

A developing device has a developer material bearing member, a toner bearing member, and an electric field generator adapted to generate an alternate first and second electric fields between the members. The members are driven to move in directions opposite to each other in the opposing region. The first electric field is an oscillating electric field which as a whole biases the toner particles from the developer material bearing member to the toner bearing member. The amount (M/A1) of the toner particles carried per unit area on the toner bearing member is 4 g/m² or less. A product (Rd×M/A1) of a ratio Rd (Sd/Sp) of the circumferential velocity Sd of the toner bearing member to the circumferential velocity Sp of the electrostatic latent image bearing member and the amount (M/A1) of the toner particles carried per unit area is 4 g/m² or more.

### CROSS-REFERENCE TO RELATED APPLICATION

This application is based on application No. 2008-314073 filed in Japan, the entire content of which is hereby incorporated by reference.

### TECHNICAL FIELD

The present invention relates to an electro-photographic image-forming apparatus and a developing device for use in this image-forming apparatus.

### BACKGROUND OF THE INVENTION

JP 2006-308687 A discloses an electro-photographic image forming apparatus which uses a hybrid developing method. The image forming apparatus uses a developing device including a developer material bearing member (magnetic roller) and a toner bearing member (developing roller). The developer material bearing member bears two-component developer material made of non-magnetic toner particles and magnetic carrier particles and, when developing, only the toner particles are selectively supplied to the toner bearing member. The toner particles on the toner bearing member are transferred to the electrostatic latent image bearing member so that the electro static latent images are visualized or developed.

The developing material on the developer material bearing member forms magnetic brushes extending along the magnetic filed lines. The magnetic brushes are brought into contacts with the toner bearing member in a region (supplying/collecting region) between the developer and toner bearing members. This cause that only the toner particles are supplied from the developer material bearing member onto the toner bearing member due to the electric field generated between the developer and toner bearing members. The toner particles on the toner bearing member are then transported into a developing region where the toner bearing member opposes the electrostatic latent image bearing member. When passing through the developing region, the toner particles are in part transferred onto the electrostatic latent image portions on the electrostatic latent image bearing member due to the electric filed formed between the toner and electrostatic latent image bearing members to visualize the electrostatic latent images. The toner particles remaining on the portions of the toner bearing member passed by the developing region are transported into the supplying/collecting where they are collected by the magnetic brushes from the toner bearing member.

During the operation, the developer and toner bearing members are biased respectively to form the supplying and collecting electric fields therebetween. Typically, the supplying and collecting electric fields are oscillating electric fields made of two alternate electric fields electrically biasing the toner particles from the developer material bearing member to the toner bearing member and vice versa. To ensure a sufficient amount of toner particles to be supplied to the toner bearing member, the electric fields are determined as a whole to bias the toner particles from the developer material bearing member to the toner bearing member.

The hybrid-developing has advantages that the toner particles are less stressed, the quality of the resultant images are improved, and fewer toner particles are scattered into the atmosphere. On the other hand, the hybrid-developing tends to generate image memories (negative-working images) in which the black and white image densities are reversed, on the toner bearing member. For example, when producing an image of solid image portions and non-image portions and then ahalftone solid image, the images of the solid and non-solid image portions appear on the halftone image in which the densities of the solid and non-solid image portions are reversed.

It has been understood that the image memories are generated if the toner particles on the toner bearing member are not completely collected therefrom by the contacts of the magnetic brushes of the developer material bearing member and therefore variations in amount of toner particles on the toner bearing member can not be eliminated thoroughly.

It may be an option to provide a collecting member for collecting toner particles from the toner bearing member in order to increase the collecting ability in the hybrid-developing, which disadvantageously increases the number of components and the resultant size of the image forming apparatus.

Alternatively, as disclosed by JP 2006-317980 A, it may be another option to reduce the amount of toner particles to be borne on the toner bearing member so that the toner particles are well removed by the magnetic brushes. However, the reduction of the amount of toner particles on the toner bearing member may result in a problem that the images are not reproduced in desired densities due to the insufficient amount of toner particles on the toner bearing member.

### SUMMARY OF THE INVENTION

Accordingly, a purpose of the invention is to provide an improved hybrid-developing technique capable of producing image having sufficient densities without increasing the number of components and preventing the generation of negative-working images.

To solve the problem, a developing device according to the invention comprises
a developer material bearing member adapted to bear thereon a developer material containing non-magnetic toner particles and magnetic carrier particles;
a toner bearing member opposing the developer material bearing member through a supplying/collecting region and an electrostatic latent image bearing member through a developing region, the toner baring member being adapted to bear thereon the toner particles supplied from the developer material bearing member at the supplying/collecting region; and
an electric field generator adapted to generate a first electric field between the developer material bearing member and the toner bearing member so as to supply and collect the toner particles therebetween and to generate a second electric field between the toner bearing member and the electrostatic latent image bearing member so as to transfer the toner particles from the toner bearing member to an electrostatic latent image area on the electrostatic latent image bearing member,
wherein the developer material bearing member and the toner bearing member are driven to move in directions opposite to each other in a region where the developer material bearing member and the toner bearing member oppose to each other,
wherein the first electric field is an oscillating electric field which as a whole biases the toner particles from the developer material bearing member to the toner bearing member,
wherein the amount (M/A1) of the toner particles carried per unit area on the toner bearing member is 4 g/m² or less, and
wherein a product (Rd×M/A1) of a ratio Rd (Sd/Sp) of the circumferential velocity Sd of the toner bearing member to the circumferential velocity Sp of the electrostatic latent image bearing member and the amount (M/A1) of the toner particles carried per unit area is 4 g/m² or more.

According to another aspect of the invention, the developing device comprises
a developer material bearing member adapted to bear thereon a developer material containing non-magnetic toner particles and magnetic carrier particles;
a toner bearing member opposing the developer material bearing member through a supplying/collecting region and an electrostatic latent image bearing member through a developing region, the toner baring member being adapted to bear thereon the toner particles supplied from the developer material bearing member at the supplying/collecting region; and
an electric field generator adapted to generate a first electric field between the developer material bearing member and the toner bearing member so as to supply and collect the toner particles therebetween and to generate a second electric field between the toner bearing member and the electrostatic latent image bearing member so as to transfer the toner particles from the toner bearing member to an electrostatic latent image area on the electrostatic latent image bearing member,
wherein the developer material bearing member and the toner bearing member are driven to move in directions opposite to each other in a region where the developer material bearing member and the toner bearing member oppose to each other,
wherein the first electric field is an oscillating electric field which as a whole biases the toner particles from the developer material bearing member to the toner bearing member,
wherein the amount (M/A1) of the toner particles carried per unit area on the toner bearing member is 4.5 g/m² or less,
wherein an absolute value |ΔVavg| of an average value of electric potential differences (Vd−Vs) between the electric potential Vd of the toner bearing member and the electric potention Vs of the developer material bearing member in the first electric field is 200 volts or less; and
wherein a product (Rd×M/A1) of a ratio Rd (Sd/Sp) of the circumferential velocity Sd of the toner bearing member to the circumferential velocity Sp of the electrostatic latent image bearing member and the amount (M/A1) of the toner particles carried per unit area is 4 g/m² or more.

According to another aspect of the invention, the developing device comprises
a developer material bearing member adapted to bear thereon a developer material containing non-magnetic toner particles and magnetic carrier particles;
a toner bearing member opposing the developer material bearing member through a supplying/collecting region and an electrostatic latent image bearing member through a developing region, the toner baring member being adapted to bear thereon the toner particles supplied from the developer material bearing member at the supplying/collecting region; and
an electric field generator adapted to generate a first electric field between the developer material bearing member and the toner bearing member so as to supply and collect the toner particles therebetween and to generate a second electric field between the toner bearing member and the electrostatic latent image bearing member so as to transfer the toner particles from the toner bearing member to an electrostatic latent image area on the electrostatic latent image bearing member,
wherein the developer material bearing member and the toner bearing member are driven to move in directions opposite to each other in a region where the developer material bearing member and the toner bearing member oppose to each other,
wherein the first electric field is an oscillating electric field which as a whole biases the toner particles from the developer material bearing member to the toner bearing member,
wherein the amount (M/A1) of the toner particles carried per unit area on the toner bearing member is 4.5 g/m² or less,
wherein a ratio Rs (Ss/Sd) of the circumferential velocity Ss of the developer material bearing member to the circumferential velocity Sd of the toner bearing member is 1 or more, and
wherein a product (Rd×M/A1) of a ratio Rd (Sd/Sp) of the circumferential velocity Sd of the toner bearing member to the circumferential velocity Sp of the electrostatic latent image bearing member and the amount (M/A1) of the toner particles carried per unit area is 4 g/m² or more.

According to the first aspect of the invention, the amount (M/A1) of the toner particles carried per unit area on the toner bearing member is 4 g/m² or less, and thus, the amount of the toner particles adhered to the surface of the toner bearing member can be sufficiently reduced. Therefore, the toner particles on the toner bearing member can be sufficiently recovered by the magnetic brush on the developer material bearing member in the supplying/collecting region, so that occurrence of the image memory can be prevented. Also, the product (Rd×M/A1) of the ratio Rd (Sd/Sp) of the circumferential velocity Sd of the toner bearing member to the circumferential velocity Sp of the electrostatic latent image bearing member and the amount (M/A1) of the carried toner particles is 4 g/m² or more. Therefore, there can be ensured a sufficient amount of the toner particles supplied from the toner bearing member to the electrostatic latent image area on the electrostatic latent image bearing member per unit time. Consequently, a sufficient image density can be obtained, even though the amount (M/A1) of the carried toner particles is 4 g/m² or less, as described above.

According to the second aspect of the invention, the amount (M/A1) of the toner particles carried per unit area on the toner bearing member is 4.5 g/m² or less, and thus, the amount of the toner particles adhered to the surface of the toner bearing member can be effectively reduced. Also, the absolute value |ΔVavg| of an average of the potential differences (Vd−Vs) between the electric potential Vd of the toner bearing member and the electric potential Vs of the developer material bearing member is 200 volts or less, and thus, the toner particles with relatively large particle sizes on the toner bearing member can be more sufficiently recovered by the magnetic brush on the developer material bearing member. Because of these advantages, occurrence of the image memory can be prevented. Further, the product (Rd×M/A1) of the ratio Rd (Sd/Sp) of the circumferential velocity Sd of the toner bearing member to the circumferential velocity Sp of the electrostatic latent image bearing member and the amount (M/A1) of the carried toner particles is 4 g/m² or more, and therefore, a sufficient image density can be obtained.

According to the third aspect of the invention, the amount (M/A1) of the toner particles carried per unit area on the toner bearing member is 4.5 g/m² or less, and thus, the amount of the toner particles adhered to the surface of the toner bearing member can be effectively reduced. Further, the ratio Rs (Ss/Sd) of the circumferential velocity Ss of the developer material bearing member to the circumferential velocity Sd of the toner bearing member is one (1) or more, and therefore, a frequency at which the magnetic brush on the developer material bearing member comes into contact with the toner particles on the toner bearing member is increased. Because of these advantages, occurrence of the image memory can be prevented. Furthermore, the product (Rd×M/A1) of the ratio Rd (Sd/Sp) of the circumferential velocity Sd of the toner bearing member to the circumferential velocity Sp of the electrostatic latent image bearing member and the amount of the carried toner particles (M/A1) is 4 g/m² or more, and therefore, a sufficient image density can be obtained.

### BRIEF DESCRIPTION OF THE DRAWINGS

FIG. 1 is a cross sectional view showing a general construction of an image forming apparatus and a developing device incorporated therein;

FIG. 2 is a diagram showing an embodiment of an electric field generating unit;

FIG. 3 is a graph showing voltages to be applied a developing roller and a conveyor roller; and

FIG. 4 is a graph showing waveforms of supplying and collecting electric fields.

### PREFERRED EMBODIMENTS OF THE INVENTION

Referring to the drawings, preferred embodiments of the invention will be described below. It should be noted that the terminologies such as “upper”, “lower”, “left”, “right”, “clockwise”, “counterclockwise”, and other combinations including such terminologies are used in the following descriptions for the better understanding of the invention in light of the attached drawings but the usages of those terminologies do not restrict the scope of the invention. Also, like reference numerals indicate like parts in the drawing.

1. Image Forming Apparatus

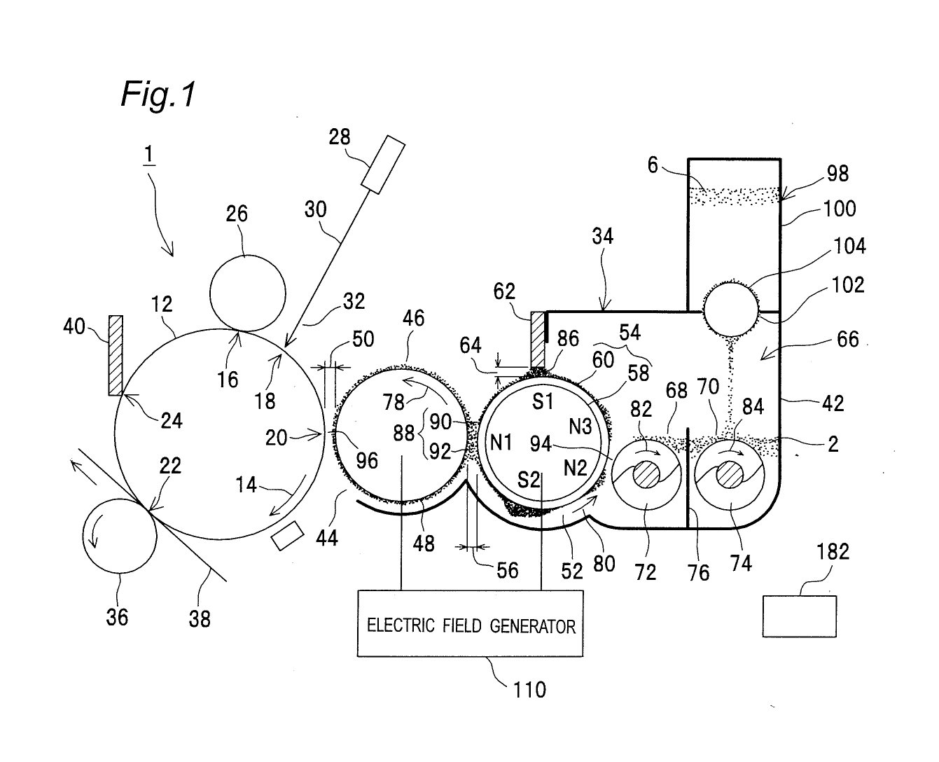

FIG. 1 shows several parts of the electro-photographic image forming apparatus, in particular, related to the image forming operations. The apparatus may be a copy machine, printing machine, facsimile machine, or multifunction peripherals (MFP) which incorporates one ore more functions of those machines in combination. The apparatus, generally indicated by reference numeral 1, has an electrostatic latent image bearing member made of a photosensitive member 12. Although the photosensitive member 12 is made of cylinder in this embodiment, the present invention is not limited thereto and it may be replaced by an endless-belt photosensitive member. The photosensitive member 12 is drivingly connected to a motor not shown so that it rotates in the direction indicated by arrow 14 by the driving of the motor. Provided around the photosensitive member 12, along the rotational direction thereof, are a charge station 16, an exposure station 18, a developing station 20, a transfer station 22, and a cleaning station 24.

The charge station 16 has a charger 26 for providing an electric charge on the photosensitive layer mounted around the peripheral surface of the photosensitive member 12. Although the charger 26 is made of cylindrical roller in this embodiment, it may be replaced by other chargers such as rotational or fixed brush-type charger or wire-type charger. The exposure station 16 has a passage 32 through which an image light 30 emitted from an exposure 28 positioned adjacent to or away from the photosensitive member 12 is projected onto the charged photosensitive layer of the photosensitive member 12. The peripheral portions of the photosensitive member 12 passed by the exposure station 18 has an electrostatic latent image including image portions where the image light has been projected to reduce the potential and non-image portions where no image light has been projected to maintain substantially the originally charged potential. The developing station 20 has a developing device 34 which uses a power developer to visualize the electrostatic latent image. Details of the developing device 34 will be described below. The transfer station 22 has a transfer device 36 for transferring the visualized image onto a sheet 38 made of paper or film. Although a cylindrical roller is used for the transfer device 36, it may be replaced by another wire-type transfer charger, for example. The cleaning station 22 has a cleaning device 40 for cleaning or collecting toner particles not transferred onto the sheet 38 but remaining on the peripheral surface of the photosensitive member 12. Although a blade-type cleaning is used for the cleaning device 40, it may be replaced by a rotational or fixed brush-type cleaning device, for example.

In the image forming operation of the image forming apparatus 1 so constructed, the photosensitive member 12 is rotated in the clockwise direction by the driving of the motor. During the rotation of the photosensitive member 12, incremental peripheral portions of the photosensitive member 12 are electrically charged to a predetermined potential. The charged peripheral portions are exposed to the image light projected at the exposure station 18 to form an electrostatic latent image. The electrostatic latent image is transported by the rotation of the photosensitive member 12 into the developing station 20 where it is visualized into a developer image by the developing device 34. The visualized developer image is then transported by the rotation of the photosensitive member 12 into the transfer station 22 where it is transferred onto the sheet 38. The sheet 38 is then transported into a fixing station not shown where the developer image is permanently fixed on the sheet 38. The peripheral portions of the photosensitive member passed by the transfer station 22 are transported into the cleaning station 24 where the untransferred residual toner particles are collected.

2. Developing Device

The developing device 34 has a casing or housing 42 for accommodating two-component developer non-magnetic toner particles (first component), magnetic carrier particles (second component), and others which will be described later. For clarity of the drawing and the better understanding of the invention, portions of the housing 42 are not illustrated in the drawing.

The housing 42 has an opening 44 opened toward the photosensitive member 12. A developing roller 48, or the toner bearing member, is mounted within a space 46 defined adjacent the opening 44. The developing roller 48, which is in the form of cylinder, is mounted for rotation and in parallel to the photosensitive member 12 while leaving a certain developing gap 50 from the photosensitive member 12.

Another space 52 is defined behind the developing roller 48, in which a conveyor roller 54 or developing material bearing member is mounted for rotation and in parallel to the developing roller 48 while leaving a certain supplying and collecting gap 56 from the developing roller 48. The conveyor roller 54 has a fixed magnet member 58 and a cylindrical sleeve 60 disposed around the magnet member 58 for rotation therearound. A regulating plate 62 is fixedly mounted above and in parallel to the sleeve 60 so as to define a regulating gap 64 between the regulating plate 62 and the sleeve 60.

The magnet member 58 has a plurality of magnetic poles each opposing to the inner surface of the sleeve 60 and extending in the direction parallel to the longitudinal axis of the conveyor roller 54. In this embodiment, the magnetic poles includes a magnetic pole S1 disposed adjacent the regulating plate 62 to oppose the upper inner surface portion of the sleeve 60, a magnetic pole N1 disposed adjacent the supplying and collecting gap 56 to oppose the left inner surface portion of the sleeve 60, a magnetic pole S2 disposed to oppose the lower inner surface potion of the sleeve 60, and a pair of neighborhood magnetic poles N2 and N3 with the same polarity.

A developer material mixing chamber 66 is defined behind the conveyor roller 54. The chamber 66 has a front passage 68 adjacent the conveyor roller 54 and a rear passage 70 away from the conveyor roller 54. A front mixing and transporting member or front screw 72 is mounted for rotation within the front passage 68 for mixing and transporting the developer material in a direction extending from the top surface to the bottom surface of this drawing. Also, a rear mixing and transporting member or rear screw 74 is mounted for rotation within the rear passage 70 for mixing and transporting the developer material in the opposite direction. Preferably, the front and rear passages, 68 and 70, are divided by a partition 76 provided therebetween. In this instance, although not shown, the far and near ends of the partition 76 are cut out to define far and near openings connecting the front and rear passages 68 and 70 so that the developer material is conveyed from the rear to front passages and vice versa through the openings.

In the developing operation by the developing device 34 so constructed, the developing roller 48 and the sleeve 60 rotate in the directions indicated by arrows 78 and 80, respectively, by the driving of the motor not shown. Therefore, the outer peripheral surface portions of the developing roller 48 and the sleeve 60 move in the opposite directions in a region where they oppose to each other. The front screw 72 rotates in the direction indicated by arrow 82 and the rear screw 74 rotates in the direction indicated by arrow 84, which causes that the developer material 2 in the chamber 66 is mixed and conveyed from the front to rear chambers while toner and carrier particles thereof repeatedly make frictional contacts with each other to have opposite electric charges, respectively. In this embodiment, the carrier particles are positively charged and the toner particles are negatively charged. As is known in the art, the carrier particles are far larger than the toner particles, so that a number of negatively charged toner particles adhere on the surfaces the positively charged carrier particles with an aid of the electrostatic forces of attraction.

The charged developer material 2 is then supplied to the conveyor roller 54 as it is being conveyed in the front passage 68 by the front screw 72. The developer material 2 is then retained on the peripheral surface of the sleeve 60 due to the magnetic force of the magnetic pole N3. As is known in the art, the developer material 2 on the sleeve 60 forms magnetic brushes extending along the magnetic force lines generated by and around the magnet member 58 and is conveyed in the counter-clockwise direction by the rotation of the sleeve 60. When passing through the regulating region 86 adjacent the regulating plate 62, an amount of the developer material 2 is regulated to a predetermined amount by the regulating plate 62. The developer material 2 is then conveyed into the supplying/collecting 88 where the developing roller 48 faces the conveyor roller 54. As will be described later, within the supplying/collecting 88, in particular, a region 90 positioned on the upstream side with respect to the rotational direction of the sleeve 60, the toner particles on the carrier particles are supplied to the developing roller 48 due to the electric field defined between the developing roller 48 and the sleeve 60. Simultaneously, within the supplying/collecting 88, in particular, a region 92 positioned on the downstream side with respect to the rotational direction of the sleeve 60, the toner particles which have not been used for developing and are being conveyed by the sleeve 60 into the region 88 are collected by the magnetic brushes on the conveyor roller 49. The carrier particles are held by the magnetic force from the magnet member 59 without moving from the sleeve 60 to the developing roller 48. The developer material 2 passed the supplying/collecting 88 is transported, as it is retained by the magnetic force from the magnet member 58, to the region adjacent the magnetic pole S2 and then the subsequent release region 94 where it is released from the sleeve 60 with an aid of the repelling magnetic field generated by the magnetic poles N2 and N3 into the front passage 68 and then mixed with the developer material being mixed therein.

The toner particles given onto the developing roller 48 at the supplying region 90 are transported by the rotation of the developing roller 48 in the counter-clockwise direction into the developing region 96 where they adhere to the image portions of the electrostatic latent image on the photosensitive member 12. In the embodiment, the peripheral surface made of photosensitive material on the photosensitive member 12 is negatively charged to a potential VH. Also, the charged surface is exposed to the image light 30 from the exposure 28 to reduce it potential to VL. The remaining non-image portions not exposed to the image light 30 maintain substantially the originally charged potential VH. Therefore, in the developing region 96, the negatively charged toner particles adhere to the image portions of the electrostatic latent image to visualize the image with an aid of the electric field generated between the photosensitive member 12 and the developing roller 48.

Preferably, to compensate for the toner particles used for development, the fresh toner particles are supplied to the developer material. For this purpose, the developing device 34 has means for measuring the mixing rate between the toner and carrier particles in the housing 42. Also, a toner supplying unit 98 is provided above the rear passage 70. The unit 98 has a container 100 for accommodating the toner particles. The container 100 has an opening 102 defined on the bottom wall thereof, in which a supply roller 104 is provided and drivingly connected to a motor not shown. This allows that the fresh toner particles are dropped and supplied into the rear passage 70 when the motor is driven in accordance with the signal indicating the mixing rate of the toner and carrier particles.

3. Developer Materials

Discussions will be made to the details of the toner and carrier particles and other components mixed in the developer material.

Toner Particles:

The conventional toner particles are used for the image apparatus. The size of the toner particles is, for example, from about 3 to about 15 micrometers. Preferably, smaller toner particles with a size of 8 micrometers or less are used. The use of smaller toner particles facilitates transference of the toner particles from the developing roller 48 to the photosensitive member 12 to obtain a sufficient image density. Other toner particles, such as toner particles including coloring agent in the binder resin, toner particles containing a charge-controlling agent or a releasing agent, and toner particles having additives retained on its surface may be used.

Preferably, the saturated charge amount of the toner particles is 40 μC/g or less, which ensures that electrostatic adhesion of the toner particles to the developing roller 48 is reduced and the toner-collecting performance by the magnetic brush is improved.

For example, the toner particles are produced by any of known methods such as a pulverization method, an emulsion polymerization method, and a suspension polymerization method.

Binder Resin:

Although not limited thereto, a binder resin for use in the toner particles is selected from the group including styrene-based resins (styrene or homopolymers or copolymers each containing a styrene substitution product), polyester resins, epoxy-based resins, vinyl chloride resins, phenol resins, polyethylene resins, polypropylene resins, polyurethane resins, silicone resins, and a mixture of some optionally selected from these resins. Preferably, the binder resin has a softening point of from about 80 to about 160 degrees Celsius and a glass transition point of from about 50 to about 75 degrees Celsius.

Coloring Agent:

The coloring agent may be any of known materials such as carbon black, aniline black, activated charcoal, magnetite, benzine yellow, permanent yellow, naphthol yellow, phthalocyanine blue, fast sky blue, ultramarine blue, rose bengal, and lake red. The amount of the coloring agent to be added is preferably from 2 to 20 parts by weight per 100 parts by weight of the binder resin.

Charge-Controlling Agent:

The charge-controlling agent may be any of conventional materials known as the charge-controlling agents. Specifically, a nigrosine-based dye, a quaternary ammonium salt-based compound, a triphenylmethane-based compound, an imidazole-based compound or a polyamine resin can be used as the charge-controlling agent for toner particles which are charged positively; and an azo dye containing a metal such as Cr, Co, Al, Fe or the like, a metal salicylate compound, a metal alkylsalicylate compound or a calyx arene compound can be used as the charge-controlling agent for the negatively charged toner particles. Preferably, 0.1 to 10 parts by weight of the charge-controlling agent is used per 100 parts by weight of the binder resin.

As the releasing agent, a conventionally known releasing agent may be used. Examples of the material for the releasing agent include polyethylene, polypropylene, carnauba wax and sasol wax, and mixtures of some thereof in appropriate combination. Preferably, the proportion of the releasing agent is from 0.1 to 10 parts by weight per 100 parts by weight of the binder resin.

Other Additives:

A fluidizing agent for accelerating the fluidization of the developer may be added. For the fluidizing agent, there can be used, for example, fine inorganic particles of silica, titanium oxide, alumina or the like, or fine resin particles of an acrylic resin, a styrene resin, a silicone resin, or a fluororesin. It is particularly preferable to use, as such an agent, a material which is hydrophobized with a silane coupling agent, a titanium coupling agent or a silicone oil. Preferably, 0.1 to 5 parts by weight of the fluidizing agent is added to 100 parts by weight of the toner particles. The number-average primary particle size of the additive is preferably from 9 to 100 nm.

Carrier:

For the carrier particles, any of conventional carrier particles may be used, and either binder type carrier particles or coating type carrier particles may be used. While the particle size of the carrier particles is not limited, it is preferably from about 15 to about 100 micrometers.

The binder type carrier particles are obtained by dispersing fine magnetic particles in a binder resin. It is also possible to use binder type carrier particles which have, on their surfaces, positively or negatively chargeable fine particles or such coating layers. The charging characteristics such as polarity of the binder type carrier particles can be controlled by selecting a material for the binder resin and the kind of chargeable fine particles or the surface coating layer.

For the binder resin for use in the binder type carrier particles, there are exemplified vinyl-based resins, typically polystyrene-based resins, thermoplastic resins such as polyester-based resins, nylon-based resins and polyolefin-based resins; and curable resins such as phenol resins.

For the fine magnetic particles for use in the binder type carrier particles, there can be used particles of magnetite, spinel ferrite such as γ-iron oxide, spinel ferrite containing at least one metal other than iron (e.g., Mn, Ni, Mg, Cu, etc.), magnetoplumbite type ferrite such as barium ferrite, iron having an oxidized layer on its surface, or alloys. The shape of the carrier particles may be particulate, globular or acicular. When high magnetization is required, iron-based ferromagnetic fine particles are preferably used. In view of chemical stability, the use of ferromagnetic fine particles of magnetite, spinel ferrite such as γ-iron oxide, or magnetoplumbite type ferrite such as barium ferrite is preferable. It is possible to obtain magnetic resin carrier particles with desired magnetization, by appropriately selecting the kind and content of the ferromagnetic fine particles. Appropriately, 50 to 90% by weight of the magnetic fine particles are added into the magnetic resin carrier particles.

For the surface-coating material for the binder type carrier particles, a silicone resin, an acrylic resin, an epoxy resin, a fluororesin or the like is used. Any of these resins is applied to the surface of the carrier particles and are cured thereon to form coating layers thereon. Thus, the charge-imparting ability of the carrier particles can be improved.

The fixing of chargeable fine particles or conductive fine particles on the surfaces of the binder type carrier particles is conducted as follows: for example, magnetic resin carrier particles and the fine particles are homogeneously mixed to adhere the fine particles to the surfaces of the magnetic resin carrier particles; and then, such carrier particles with the fine particles are allowed to undergo a mechanical and thermal impact to thereby drive the fine particles into the magnetic resin carrier particles, so that the fine particles are fixed to the carrier particles. In this case, the fine particles are not completely buried in the magnetic resin carrier particles, but parts of the fine particles are exposed over the surfaces of the magnetic resin carrier particles. For the chargeable fine particles, an organic or inorganic insulating material is used. Specific examples of the organic insulating material include polystyrene, styrene-based copolymers, acrylic resins, acrylic copolymers, nylon, polyethylene, polypropylene and fluororesins, and crosslinked products of them. It is possible to adjust the charge-imparting ability and the charged polarity, by selecting a material for the chargeable fine particles, a polymerization catalyst, surface-treatment, etc. As the inorganic insulating material, there are used inorganic fine particles such as silica and titanium dioxide which are charged negatively, and inorganic fine particles such as strontium titanate and alumina which are charged positively.

The coating type carrier particles comprise core particles of a magnetic material, coated with resin layers. Positively or negatively chargeable fine particles may be fixed on the surfaces of the carrier particles, as well as the binder type carrier particles. The charging characteristics of the coating type carrier particles, such as polarity, etc., can be controlled by selecting the kinds of the surface-coating layers and the chargeable fine particles. As the coating resin, the same resins as the binder resins for use in the binder type carrier particles can be used.

The mixing ratio of the toner particles and the carrier particles may be so controlled that the toner particles can be desirably charged. The proportion of the toner particles is from 3 to 50% by weight, preferably from 6 to 30% by weight, based on the total weight of the toner particles and the carrier particles.

Charged Particles:

In order that the carrier particles can have a longer lifetime, charged particles (or implant particles) which are brought into frictional contact with toner particles to thereby charge the toner particles to have normal polarity may be added as a third component to the two-component developer. Addition of charged particles produces the following effect: even if spents form on the surfaces of the carrier particles, the charged particles are driven into the spents, so that the toner particles are able to have stable chargeability over a long period of time. Suitable charged particles are appropriately selected in accordance with the polarity of charged toner particles. In case where there are used toner particles which are brought into frictional contact with carrier particles to be charged negatively, fine particles which are brought into frictional contact with the toner particles to be charged positively are used as the charged particles. Specifically, strontium titanate is used as such charged particles.

4. Material for Developing Roller

For the developing roller 48, for example, there is used an electrically conductive roller made of a metallic material such as a surface-treated aluminum material. Again, as the developing roller 48, there may be used a roller obtained by applying a coating material such as a resin or rubber to the outer peripheral surface of an electrically conductive substrate made of aluminum or the like. In this case, for the coating material, there are exemplified resins such as polyester resins, polycarbonate resins, acrylic resins, polyethylene resins, polypropylene resins, urethane resins, polyamide resins, polyimide resins, polysulfone resins, polyether ketone resins, vinyl chloride resins, vinyl acetate resins, silicon resins and fluororesins; and rubbers such as silicone rubber, urethane rubber, nitrile rubbler, natural rubber and isoprene rubber. When the coating material is used, an electron-introducing agent or an ion-introducing agent may be added to the coating material. For the electron-introducing agent, for example, there is used carbon black such as ketjen black, acetylene black or furnace black, metal powder or fine particles of metal oxide. For the ion-introducing agent, for example, there is used a cationic compound such as quaternary ammonium salt, an amphoteric compound, or other ionic polymeric material.

5. Amount of Toner Particles on Developing Roller

Preferably, the amount (M/A1) of toner particles carried per unit area on the developing roller 48 is 1 g/m² or more. Under this condition, the amount of toner particles required for development can be ensured on the developing roller 48. The amount (M/A1) of toner particles carried per unit area on the developing roller 48 is preferably 4.5 g/m² or less, desirably 4 g/m² or less. Under this condition, the adhesion of the toner particles to the outer surface of the developing roller 48 can be sufficiently reduced, so that the toner particles on the developing roller 48 can be sufficiently scraped away by the magnetic brush on the conveyer roller 54. Accordingly, the toner collecty performance by the magnetic brush can be improved, so that occurrence of an image memory can be prevented. It is possible to adjust the amount (M/A1) of toner particles carried per unit area on the developing roller 48, as will be described later: that is, an electric field between the developing roller 48 and the conveyer roller 54 is varied by the electric field generating unit 110 to thereby adjust the same amount of the toner particles.

6. Ratio of Circumferential Velocities of Rollers

The circumferential velocity Sp of the photosensitive member 12, the circumferential velocity Sd of the developing roller 48 and the circumferential velocity Ss of the conveyer roller 54 (or the sleeve 60) are appropriately controlled by the control unit 182 which is located at an optional position of the image-forming apparatus 1.

The ratio Rd (Sd/Sp) of the circumferential velocity (Sd) of the developing roller 48 to the circumferential velocity (Sp) of the photosensitive member 12 is preferably one or more. Under this condition, such an amount of the toner particles as required for development can be supplied from the developing roller 48 to an electrostatic latent image area on the photosensitive member 12. Again, this ratio Rd (Sd/Sp) is preferably 4 or less. Under this condition, the developing roller 48 can be prevented from rotating at an excessively high speed, so that heating of the developing device 34 in association with the high-speed rotation of the developing roller 48 can be prevented.

In the meantime, the amount of the toner particles supplied from the developing roller 48 to the electrostatic latent image area on the photosensitive member 12 for a unit time is affected by a product (Rd×M/A1) of the circumferential velocity ratio Rd (Sd/Sp) and the amount (M/A1) of the carried toner particles. In order to supply a sufficient amount of the toner particles from the developing roller 48 to the electrostatic latent image area on the photosensitive member 12, the product (Rd×M/A1) is preferably 4 g/m² or more. Under this condition, a sufficient image density can be obtained.

The ratio Rs (Ss/Sd) of the circumferential velocity (Ss) of the conveyer roller 54 to the circumferential velocity (Sd) of the developing roller 48 is preferably one (1) or more. By increasing the rotating speed of the conveyer roller 54 as described above, a frequency at which the magnetic brush on the conveyer roller 54 comes into contact with the toner particles on the developing roller 48 is increased, so that the toner-collecty performance by the magnetic brush can be improved. In this case, occurrence of the image memory can be more reliably prevented, accordingly.

7. Electric Field Generator

A specific example of the electric field generator for use in case where charged toner particles have negative polarity will be described.

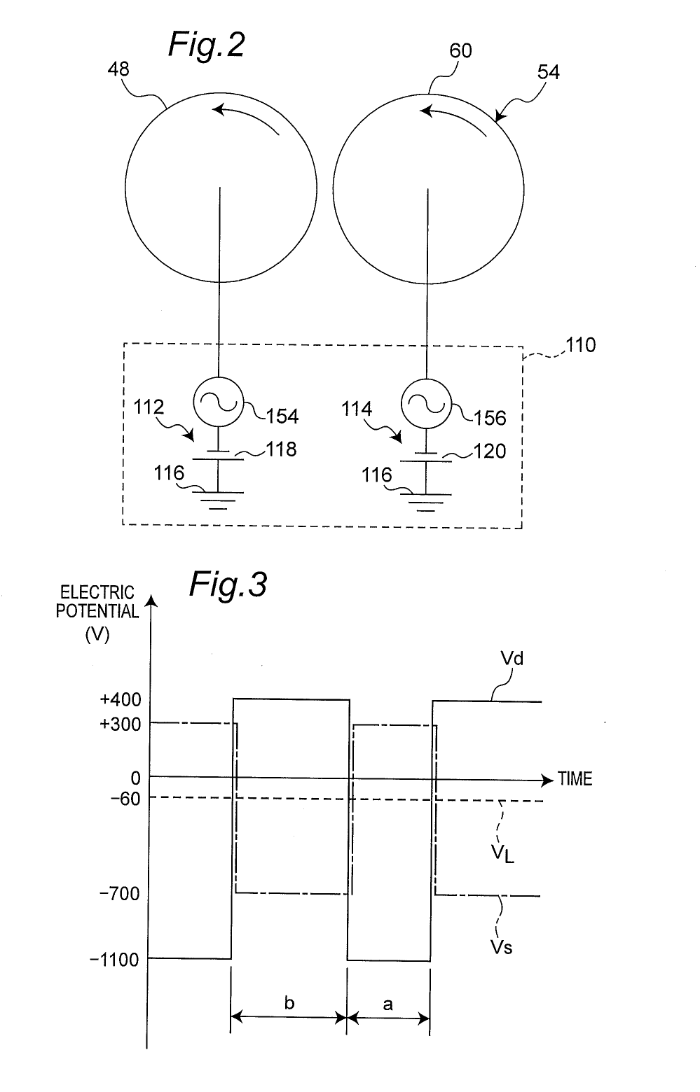

The developing roller 48 and the conveyer roller 54 are electrically connected to the electric field generating unit 110, so as to generate a supplying/collecting electric field as a first electric field for supplying or collecting toner particles, between the conveyer roller 54 and the developing roller 48, and so as to generate a developing electric field as a second electric field for transferring the toner particles from the conveyer roller 54 to the electrostatic latent image area on the photosensitive member 12, between the developing roller 48 and the photosensitive member 12. The operation of the electric field generating unit 110 is controlled by the control unit 182. The electric field generating unit 110 is so constituted as to generate a supplying/collecting electric field including an oscillating electric field along a direction in which the toner particles are supplied, as a whole, from the conveyer roller 54 to the developing roller 48. Specifically, the electric field generating unit 110 is constituted, for example, as shown in FIG. 2.

In FIG. 2, the electric field generating unit 110 includes a first power supply 112 connected to the developing roller 48, and a second power supply 114 connected to the sleeve 60 of the conveyer roller 54.

The first power supply 112 includes a DC power supply 118 and an AC power supply 154 between the developing roller 48 and the ground 116. The DC power supply 118 applies a DC voltage (for example, −350 volts) having the same polarity as that of the charged toner particles, to the developing roller 48. The AC power supply 154 applies an AC voltage with an amplitude (a peak-to-peak voltage) of, for example, 1,500 volts and a frequency of, for example, 3 kHz, across the developing roller 48 and the ground 116. That is, a bias generated by superimposing the DC voltage on the AC voltage is applied to the developing roller 48, so that the electric potential Vd of the developing roller 48 periodically changes so as to repeat a high potential state (for example, +400 volts) and a low potential state (for example, −110 volts), alternately (see FIG. 3). In this regard, the high potential state means that the electric potential Vd of the developing roller 48 is higher than the electric potential V_{L} of the electrostatic latent image area on the photosensitive member 12. The low potential state means that the electric potential Vd of the developing roller 48 is lower than the electric potential V_{L} of the electrostatic latent image area on the photosensitive member 12. The electric potential V_{L} of the electrostatic latent image area is preferably, for example, −100 volts or higher and −50 volts or lower, more preferably, for example, −60 volts.

The second power supply 114 includes a DC power supply 120 and an AC power supply 156 between the conveyer roller 54 and the ground 116. The DC power supply 120 applies a DC voltage (for example, −200 volts) having the same polarity as that of the charged toner particles, to the conveyer roller 54. The AC power supply 156 applies an AC voltage with an amplitude (a peak-to-peak voltage) of, for example, 1,000 volts and a frequency of, for example, 3 kHz, across the conveyer roller 54 and the ground 116. This means that a bias generated by superimposing the DC voltage on the AC voltage is applied to the conveyer roller 54, so that the electric potential Vs of the conveyer roller 54 periodically changes so as to repeat a low potential state (for example, −700 volts) and a high potential state (for example, +300 volts), alternately (see FIG. 3). In this regard, the low potential state means that the electric potential Vs of the conveyer roller 54 is lower than the electric potential of the developing roller 48. The high potential state means that the electric potential Vs of the conveyer roller 54 is higher than the electric potential of the developing roller 48.

As shown in FIG. 3, the voltage Vd applied to the developing roller 48 and the voltage Vs applied to the conveyer roller 54 have the same frequency (a+b). The duty ratio of the voltage Vd on the low electric potential side is the same as that of the voltage Vs on the high electric potential side (i.e., a/(a+b)×100).

As described above, the amount (M/A1) of the toner particles per unit area on the developing roller 48 can be adjusted by varying the supplying/collecting electric field. To vary the supplying/collecting electric field, at least one of the voltage Vd applied to the developing roller 48 and the voltage Vs applied to the conveyer roller 54 is varied. Preferably, the amount (M/A1) of the toner particles carried per unit area is adjusted by varying the voltage Vs, because the variation of the voltage Vd gives some influence on the development. In concrete, it is preferable to adjust the amount (M/A1) of the toner particles carried per unit area by varying the amplitude (peak-to-peak voltage) of the voltage Vs and/or the DC component thereof.

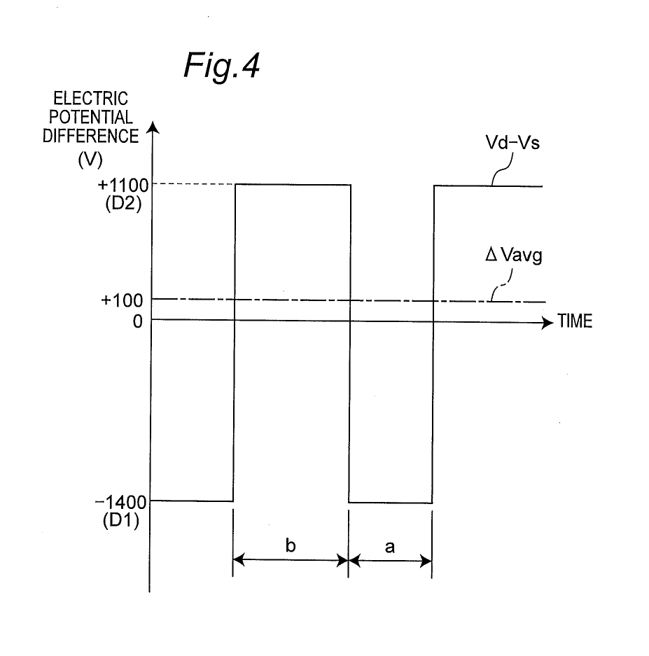

The supplying/collecting electric field is made by an electric potential difference (Vd−Vs) between the voltage Vd applied to the developing roller 48 and the voltage Vs applied to the conveyer roller 54. As shown in FIG. 4, the electric potential difference (Vd−Vs) is a given negative value D1 (for example, −1,400 volts) during a period of time indicated by alphabet “a”, and it is a given positive value D2 (for example, +1,100 volts) during a period of time indicated by alphabet “b”. Thus, the supplying/collecting electric field is produced by repeating an electric field toward a direction in which the toner particles are supplied from the conveyer roller 54 to the developing roller 48, and an electric field toward a direction in which the toner particles are collected from the developing roller 48 to the conveyer roller 54, alternately. An average value ΔVavg of the electric potential differences (Vd−Vs) is a positive value (for example, +100 V). Thus, the supplying/collecting electric field is an oscillating electric field toward a direction in which the toner particles are supplied, as a whole, from the conveyer roller 54 to the developing roller 48. The average value ΔVavg can be calculated by the following equation 1:

ΔVavg=(D2×b−D1×a)/(a+b) (1).

As described above, the supplying/collecting electric field is an electric field toward a direction in which the toner particles are supplied, as a whole, from the conveyer roller 54 to the developing roller 48, and therefore, the average value ΔVavg of the electric potential differences (Vd−Vs) is 0 volt or more. Preferably, the average value ΔVavg of the electric potential differences is 200 V or less, in order to avoid lack of the amount of the toner particles collected from the developing roller 48 to the conveyer roller 54. This means that the average value ΔVavg is preferably 0 volt or more and 200 volts or less. Therefore, in the present invention, the absolute value |ΔVavg| of the average value is preferably 200 volts or less, taken into account also the case where the polarity of charged toner particles is positive. In this case, the toner particles with relatively large particle sizes on the developing roller 48 also can be sufficiently collected, so that deviation of the particle sizes of the toner particles carried on the developing roller 48 is hard to occur. Consequently, variation in the amount of the toner particles adhered to the outer surface of the developing roller 48 is hard to occur, and therefore, occurrence of the image memory can be reliably prevented.

While the present invention has been fully described by way of the foregoing embodiments, the scope of the present invention is not limited to these embodiments in any way.

For example, the first power supply 112 and the second power supply 114 which together constitute the electric field generating unit 110 do not necessarily include the AC power supplies, respectively. For example, one of the first power supply 112 and the second power supply 114 may be made of DC power supply.

Tests

To confirm the advantages derived from the present invention, the following tests were conducted.

In the tests, Examples A to I and Comparative Examples A to I were set for evaluation, and the respective Examples and Comparative Examples were evaluated with respect to image memory, image density and heating of the developing device.

In each of Examples and Comparative Examples, the amount (M/A1) of toner particles carried per unit area on the developing roller, the ratio Rd of the circumferential velocity of the developing roller to that of the photosensitive member, the ratio Rs of the circumferential velocity of the conveyer roller to that of the developing roller, and the average value ΔVavg of the electric potential differences (Vd−Vs) between the developing roller and the conveyer roller were set at the values indicated in Tables 1A and 1B.

The image memory was so evaluated that a sample chart for use in evaluation of a memory (i.e., image comprising a mixed portion of solid portions and blank portions, and a halftone image portion printed following the mixed portion) was printed and whether or not an image memory occurred on the halftone image portion was visually observed. Specifically, the image memory was determined to occur, when the density of a portion corresponding to the solid portion of the mixed portion was lower than the density of other portions. In Tables 1A and 1B, the image memory was evaluated based on the following criteria:

A: no image memory occurred,

B: a very slight image memory occurred depending on an environmental condition, and

C: a clear image memory occurred.

The evaluation of an image density was so conducted that a solid image formed on an intermediate transfer belt was peeled off by the use of a cellophane tape, and the density of the solid image adhered to the cellophane tape was detected with a Machbeth transmission densitometer TD904 (manufactured by GretagMachbeth AG); and whether or not the detected density was 0.90 or more was confirmed. In Tables 1A and 1B, the solid image was marked with “A”, when an image density of 0.90 or more was obtained, or the solid image was marked with “B”, when an image density of 0.90 or more was not obtained.

The heating of the developing device was so evaluated that an ambient temperature around the developing device which had been used to print a solid image on 1,000 sheets of paper was detected with a temperature sensor; and whether or not the ambient temperature was 100 degrees Celsius or higher was confirmed. In Tables 1A and 1B, the heating of the developing device was evaluated based on the following criteria:

A: heating of the developing device was confirmed, and

B: no heating of the developing device was confirmed.

As the toner particles of the developer, toner particles “a” or toner particles “b” produced by the following methods were used. The polarities of both of the toner particles “a” and “b” were negative.

The toner particles “a” were produced by externally adding a first hydrophobic silica (0.2 parts by weight), a second hydrophobic silica (0.5 parts by weight) and a hydrophobic titanium oxide (0.5 parts by weight) to toner base material particles with a volume-average particle size of about 6.5 micrometers (100 parts by weight) obtained by the wet granulation. The external addition treatment was conducted as follows: a Henschel mixer manufactured by MITSUI MINING COMPANY, LIMITED was driven at a speed of 40 m/second for 3 minutes to mix the above-described materials. Of the above-described materials, the first hydrophobic silica was obtained by surface-treating silica with a number-average primary particle size of 16 nm (AEROSIL® 130 manufactured by NIPPON AEROSIL CO., LTD.) with hexamethyldisilazane (HMDS) as a hydrophobizing agent; the second hydrophobic silica was obtained by surface-treating silica with a number-average primary particle size of 20 nanometers (AEROSIL® 90 manufactured by NIPPON AEROSIL CO., LTD.) with HMDS; and the hydrophobic titanium oxide was obtained by surface-treating anatase titanium oxide with a number-average primary particle size of 30 nanometers, with isobutyltrimethoxy-silane as a hydrophobizing agent in a liquid.

The toner particles “b” were produced by the same method as in the production of the toner particles “a”, except that toner base material particles with a volume-average particle size of about 9 micrometers were used.

As the carrier particles of the developer, carrier particles for use in bizhub C350 manufactured by Konica Minolta Technologies, Inc. were used. The carrier particles were coating type carrier particles with an average particle size of about 33 micrometers, each of which comprised a carrier core particle of a magnetic material, coated with a silicone resin.

The content of the toner particles in the developer was 8%, while the content of the toner particles in the developer used in Comparative Example G alone was 6%. The toner content herein referred to means a ratio of the total amount of the toner particles and the externally added materials to the entire amount of the developer.

As the image-forming apparatus, a remodeled color complex machine bizhub C350 manufactured by Konica Minolta Technologies, Inc. was used.

As the developing roller, a roller with a diameter of 16 mm was used, and as the conveyer roller, a roller with a diameter of 18 mm was used. Specifically, an aluminum roller surface-treated with alumite was used as the developing roller. The narrowest gap between the conveyer roller and the developing roller was 0.3 millimeters. The interval between the conveyer roller and the regulator plate was 0.4 millimeters. By this designing, the magnetic brush on the conveyer roller could have a height enough for frictional contact with the outer surface of the developing roller.

The electric potential of the electrostatic non-latent image area on the photosensitive member was set at −550 volts. The electric potential of the electrostatic latent image area on the photosensitive member was set at −60 volts. The narrowest gap between the photosensitive member and the developing roller was set at 0.135 millimeters. The circumferential velocity of the photosensitive member (or a processing speed) was set at 310 millimeters per second.

The voltage Vd was applied to the developing roller, and the voltage Vs was applied to the conveyer roller (see FIG. 3). The frequencies of the voltages Vd and Vs were set to be equal to each other, and the frequencies were set for each of Examples and Comparative Examples as shown in Tables 2A and 2B. The duty ratios of the voltages Vd and the voltages Vs were also set to be equal to each other; and the duty ratio on the collecting side of the toner particles from the developing roller to the conveyer roller (on the collecting side) was set as shown in Tables 2A and 2B.

The amplitude and the DC component of the voltage Vd, and the amplitude and the DC component of the voltage Vs were set for each of Examples and Comparative Examples as shown in Tables 2A and 2B, so that the amount (M/A1) of the toner particles carried on the developing roller and the average value ΔVavg of the electric potential difference (Vd−Vs) could be the values indicated in Tables 1A and 1B. In any of Examples and Comparative Examples, setting was so made that the average value ΔVavg could be a positive value. By setting so, a supplying/collecting electric field between the developing roller and the conveyer roller could be generated toward a direction in which the toner particles were supplied, as a whole, from the conveyer roller to the developing roller.

The circumferential velocities (or the numbers of rotations) of the developing roller and the conveyer roller were set for each of Examples and Comparative Examples, as shown in Tables 2A and 2B, so that the ratio Rd of the circumferential velocity of the developing roller to that of the photosensitive member, and the ratio Rs of the circumferential velocity of the conveyer roller to that of the developing roller could be the values as indicated in Tables 1A and 1B.

TABLE 1A

| | Carried | | | | | | | | |
|---|---|---|---|---|---|---|---|---|---|
| | toner | | | | Average | | | | |
| | amount | Circumferential | | | value | | | | |
| | M/Al | velocity | Rd x | Circumferential | DVavg | Toner | Image | Image | |
| | [g/m²] | ratio | M/Al | velocity | [V] | used | memory | density | Heating |
| Ex. A | 3 | 2.5 | 7.5 | 1 | 100 | a | A | A | A |
| Ex. B | 4.5 | 2.5 | 11.25 | 1.2 | 150 | a | A | A | A |
| Ex. C | 4.5 | 2 | 9 | 1 | 140 | a | A | A | A |
| Ex. D | 4.5 | 2.3 | 10.35 | 1.5 | 145 | a | A | A | A |
| Ex. E | 4.5 | 1.5 | 6.75 | 1.5 | 100 | a | A | A | A |
| Ex. F | 4.5 | 2 | 9 | 1 | 180 | a | A | A | A |
| Ex. G | 2 | 2 | 4 | 1.5 | 70 | a | A | A | A |
| Ex. H | 2 | 2 | 4 | 1.5 | 30 | a | A | A | A |
| Ex. I | 2 | 2 | 4 | 1.5 | 50 | a | A | A | A |
| Ex. J | 4 | 1.5 | 6 | 1.5 | 80 | a | A | A | A |

TABLE 1B

| | Carried | | | | | | | | |
|---|---|---|---|---|---|---|---|---|---|
| | toner | | | | Average | | | | |
| | amount | Circumferential | | | value | | | | |
| | M/Al | velocity | Rd x | Circumferential | DVavg | Toner | Image | Image | |
| | [g/m²] | ratio | M/Al | velocity | [V] | used | memory | density | Heating |
| C.Ex. A | 2.5 | 1.5 | 3.75 | 2 | 70 | a | A | B | A |
| C.Ex. B | 1.5 | 5 | 7.5 | 0.5 | 30 | a | A | A | B |
| C.Ex. C | 5 | 3 | 15 | 1 | 200 | a | C | A | A |
| C.Ex. D | 4.5 | 2.5 | 11.25 | 1.2 | 220 | a | C | A | A |
| C.Ex. E | 3 | 2.5 | 7.5 | 1 | 130 | b (9 μm) | A | B | A |
| C.Ex. F | 4.5 | 2 | 9 | 0.5 | 150 | a | B | A | A |
| C.Ex. G | 4.5 | 2.3 | 10.35 | 1.5 | 160 | a (6%) | B | A | A |
| C.Ex. H | 4.5 | 1.5 | 6.75 | 1.5 | 250 | a | C | A | A |

TABLE 2A

| | Voltages Vd and Vs applied to | | | | | | | |
|---|---|---|---|---|---|---|---|---|
| | developing roller and conveyer roller | | | | | | Number of | Number of |
| | Common | | | | | | Rotations | rotations |
| | Duty | | Vd | | Vs | | of | of |
| | ratio | | | DC | | DC | developing | conveyer |
| | on | Frequency | Amplitude | compo- | Amplitude | compo- | roller | roller |
| | side [%] | [kHz] | [V] | [V] | [V] | [V] | [rpm] | [rpm] |
| Ex. A | 40 | 3 | 1500 | −350 | 1000 | −200 | 926 | 823 |
| Ex. B | 35 | 2.5 | 1400 | −380 | 1200 | −140 | 926 | 988 |
| Ex. C | 30 | 2 | 1600 | −330 | 700 | −10 | 740 | 658 |
| Ex. D | 45 | 3.5 | 1500 | −340 | 700 | −375 | 852 | 1136 |
| Ex. E | 45 | 2 | 1300 | −360 | 1300 | −330 | 555 | 740 |
| Ex. F | 30 | 3 | 1500 | −360 | 1100 | −20 | 740 | 658 |
| Ex. G | 40 | 3 | 1400 | −380 | 1000 | −210 | 740 | 987 |
| Ex. H | 30 | 2 | 1600 | −330 | 900 | 140 | 740 | 987 |
| Ex. I | 35 | 2.5 | 1500 | −340 | 1000 | 110 | 740 | 987 |
| Ex. J | 45 | 2 | 1300 | −360 | 1300 | −310 | 555 | 740 |
| Ex. K | 30 | 3 | 1500 | −360 | 1100 | −10 | 740 | 658 |

TABLE 2B

| | Voltages Vd and Vs applied to | | | | | | | |
|---|---|---|---|---|---|---|---|---|
| | developing roller and conveyer roller | | | | | | Number of | Number of |
| | Common | | | | | | Rotations | rotations |
| | Duty | | Vd | | Vs | | of | of |
| | ratio | | | DC | | DC | developing | conveyer |
| | on | Frequency | Amplitude | compo- | Amplitude | compo- | roller | roller |
| | side [%] | [kHz] | [V] | [V] | [V] | [V] | [rpm] | [rpm] |
| C.Ex. A | 30 | 3 | 1600 | −400 | 800 | 10 | 555 | 987 |
| C.Ex. B | 35 | 3 | 1400 | −450 | 600 | −180 | 1851 | 823 |
| C.Ex. C | 45 | 3 | 1500 | −330 | 800 | −415 | 1111 | 988 |
| C.Ex. D | 35 | 2.5 | 1400 | −380 | 600 | −300 | 926 | 988 |
| C.Ex. E | 40 | 3 | 1500 | −360 | 1000 | −240 | 926 | 823 |
| C.Ex. F | 30 | 2 | 1600 | −330 | 700 | −20 | 740 | 329 |
| C.Ex. G | 45 | 3.5 | 1500 | −360 | 700 | −410 | 852 | 1136 |
| C.Ex. H | 30 | 4 | 1300 | −360 | 1100 | −130 | 555 | 740 |
| C.Ex. I | 30 | 5 | 1000 | −380 | 1300 | −220 | 740 | 658 |

Discussions will be made to the test results. As shown in Tables 1A and 1B, the image memory occurred in Comparative Example C in which the amount (M/A1) of the toner particles carried per unit area on the developing roller was 5 g/m², while no image memory occurred in any of Examples A to I in which the amount (M/A1) of the toner particles carried per unit area on the developing roller was 4.5 g/m² or less. It was confirmed from this fact that the amount (M/A1) of the toner particles carried per unit area is preferably 4.5 g/m² or less, in order to prevent any image memory.

Also, the image density was insufficient in Comparative Example A in which the product (Rd×M/A1) of the ratio Rd of the circumferential velocity of the developing roller to that of the photosensitive member and the amount (M/A1) of the toner particles carried per unit area was 3.75 g/m², while a sufficient image density was obtained in any of Examples A to I in which the product (Rd×M/A1) was 4 g/m² or more. It was confirmed from this fact that the product (Rd×M/A1) is preferably 4 g/m² or more, in order to obtain a desired image density.

Further, the heat generation at the developing device was confirmed in Comparative Example B in which the ratio Rd of the circumferential velocity of the developing roller to that of the photosensitive member was 5, while heat generation was confirmed in any of Examples A to I in which the circumferential velocity ratio Rd was 4 or less. It was confirmed from this fact that the circumferential velocity ratio Rd was preferably 4 or less, in order to prevent heating of the developing device.

Furthermore, the image memory occurred despite the fact that the amount (M/A1) of the toner particles carried per unit area was 4.5 g/m² or less, in any of Comparative Examples D, H and I in which the average value ΔVavg of the electric potential difference (Vd−Vs) between the developing roller and the conveyer roller was larger than 200 V. In contrast, no image memory occurred in any of Examples A to I in which the average value ΔVavg of the electric potential difference (Vd−Vs) was 200 volts or smaller. It was confirmed from this fact that the average value ΔVavg of the electric potential difference (Vd−Vs) was preferably 200 volts or smaller, in order to more surely prevent any image memory.

Still furthermore, the very slight image memory occurred, depending on an environmental condition, despite the fact that the amount (M/A1) of the toner particles carried per unit area was 4.5 g/m² or less, in Comparative Example F in which the ratio Rs of the circumferential velocity of the conveyer roller to that of the developing roller was 0.5. In contrast, no image memory occurred in Example C which was equal to Comparative Example F in the amount (M/A1) of the toner particles carried per unit area and the circumferential velocity ratio Rd, and was different from Comparative Example F in that the circumferential velocity ratio Rs was 1. It was confirmed from this fact that it was preferable to increase the contact frequency between the magnetic brush on the conveyer roller and the toner particles on the developing roller, by setting the circumferential velocity ratio Rs of the conveyer roller at 1 or more, in order to more reliably prevent any image memory. In this regard, no image memory occurred in Comparative Example B in which the circumferential velocity ratio Rs was 0.5, as well as Comparative Example F, but in which the circumferential velocity ratio Rd was larger, so that the contact frequency between the toner particles on the developing roller and the magnetic brush was higher, with the result that no image memory occurred.

Still furthermore, the image density was low in Comparative Example E in which the toner particles “b” with a particle size of about 9 micrometers were used. In contrast, the image density was sufficient in Example A which was equal to Comparative Example E in the amount (M/A1) of the toner particles carried per unit area and the circumferential velocity ratios Rd and Rs, and was different from Comparative Example E in that the toner particles “a” (particle size: about 6.5 micrometers) were used. It was confirmed from this fact that the use of toner particles with a particle size of so small as 8 micrometers or less is preferable in order to obtain a desired image density.

Still furthermore, the image memory occurred, depending on an environmental condition, in Comparative Example G in which the toner content was 6%. In contrast, no image memory occurred in Example D which was equal to Comparative Example G in the amount (M/A1) of the toner particles carried per unit area and the circumferential velocity ratios Rd and Rs, and was different from Comparative Example G in that the toner content was 8%. After the evaluation of the image memories, the charged amounts of the toner particles in the developing devices used in Example D and Comparative Example G were measured. As a result, the charged amount of the toner particles in Example D was 35 μC/g, and that of the toner particles in Comparative Example G was 50 μC/g. It was considered from this fact that, in order to more reliably prevent any image memory, it was effective to improve the toner-collecting performance by preventing an increase in the charge amount of the toner particles to thereby reduce the adhesion of the toner particles to the outer surface of the developing roller. It was therefore confirmed that it was preferable to set the saturation charged amount of the toner particles at 40 μC/g or less, in order to surely prevent any image memory.

1. A developing device, comprising:
a developer material bearing member adapted to bear thereon a developer material containing non-magnetic toner particles and magnetic carrier particles;
a toner bearing member opposing the developer material bearing member through a supplying/collecting region and an electrostatic latent image bearing member through a developing region, the toner baring member being adapted to bear thereon the toner particles supplied from the developer material bearing member at the supplying/collecting region; and
an electric field generator adapted to generate a first electric field between the developer material bearing member and the toner bearing member so as to supply and collect the toner particles therebetween and to generate a second electric field between the toner bearing member and the electrostatic latent image bearing member so as to transfer the toner particles from the toner bearing member to an electrostatic latent image area on the electrostatic latent image bearing member,
wherein the developer material bearing member and the toner bearing member are driven to move in directions opposite to each other in a region where the developer material bearing member and the toner bearing member oppose to each other,
wherein the first electric field is an oscillating electric field which as a whole biases the toner particles from the developer material bearing member to the toner bearing member,
wherein the amount (M/A1) of the toner particles carried per unit area on the toner bearing member is 4 g/m² or less, and
wherein a product (Rd×M/A1) of a ratio Rd (Sd/Sp) of the circumferential velocity Sd of the toner bearing member to the circumferential velocity Sp of the electrostatic latent image bearing member and the amount (M/A1) of the toner particles carried per unit area is 4 g/m² or more.

2. The developing device of claim 1, wherein the circumferential velocity ratio Rd (Sd/Sp) is 4 or less.

3. An image-forming apparatus comprising the developing device defined in claim 1.

4. A developing device, comprising:
a developer material bearing member adapted to bear thereon a developer material containing non-magnetic toner particles and magnetic carrier particles;
a toner bearing member opposing the developer material bearing member through a supplying/collecting region and an electrostatic latent image bearing member through a developing region, the toner baring member being adapted to bear thereon the toner particles supplied from the developer material bearing member at the supplying/collecting region; and
an electric field generator adapted to generate a first electric field between the developer material bearing member and the toner bearing member so as to supply and collect the toner particles therebetween and to generate a second electric field between the toner bearing member and the electrostatic latent image bearing member so as to transfer the toner particles from the toner bearing member to an electrostatic latent image area on the electrostatic latent image bearing member,
wherein the developer material bearing member and the toner bearing member are driven to move in directions opposite to each other in a region where the developer material bearing member and the toner bearing member oppose to each other,
wherein the first electric field is an oscillating electric field which as a whole biases the toner particles from the developer material bearing member to the toner bearing member,
wherein the amount (M/A1) of the toner particles carried per unit area on the toner bearing member is 4.5 g/m² or less,
wherein an absolute value |ΔVavg| of an average value of electric potential differences (Vd−Vs) between the electric potential Vd of the toner bearing member and the electric potention Vs of the developer material bearing member in the first electric field is 200 volts or less; and
wherein a product (Rd×M/A1) of a ratio Rd (Sd/Sp) of the circumferential velocity Sd of the toner bearing member to the circumferential velocity Sp of the electrostatic latent image bearing member and the amount (M/A1) of the toner particles carried per unit area is 4 g/m² or more.

5. The developing device of claim 4, wherein the circumferential velocity ratio Rd (Sd/Sp) is 4 or less.

6. An image-forming apparatus comprising the developing device defined in claim 4.

7. A developing device, comprising:
a developer material bearing member adapted to bear thereon a developer material containing non-magnetic toner particles and magnetic carrier particles;
a toner bearing member opposing the developer material bearing member through a supplying/collecting region and an electrostatic latent image bearing member through a developing region, the toner baring member being adapted to bear thereon the toner particles supplied from the developer material bearing member at the supplying/collecting region; and
an electric field generator adapted to generate a first electric field between the developer material bearing member and the toner bearing member so as to supply and collect the toner particles therebetween and to generate a second electric field between the toner bearing member and the electrostatic latent image bearing member so as to transfer the toner particles from the toner bearing member to an electrostatic latent image area on the electrostatic latent image bearing member,
wherein the developer material bearing member and the toner bearing member are driven to move in directions opposite to each other in a region where the developer material bearing member and the toner bearing member oppose to each other,
wherein the first electric field is an oscillating electric field which as a whole biases the toner particles from the developer material bearing member to the toner bearing member,
wherein the amount (M/A1) of the toner particles carried per unit area on the toner bearing member is 4.5 g/m² or less,
wherein a ratio Rs (Ss/Sd) of the circumferential velocity Ss of the developer material bearing member to the circumferential velocity Sd of the toner bearing member is 1 or more, and
wherein a product (Rd×M/A1) of a ratio Rd (Sd/Sp) of the circumferential velocity Sd of the toner bearing member to the circumferential velocity Sp of the electrostatic latent image bearing member and the amount (M/A1) of the toner particles carried per unit area is 4 g/m² or more.

8. The developing device of claim 7, wherein the circumferential velocity ratio Rd (Sd/Sp) is 4 or less.

9. An image-forming apparatus comprising the developing device defined in claim 7.
